(19) United States
(12) Patent Application Publication
(10) Pub. No.: US 2006/0088171 A1
(43) Pub. Date: Apr. 27, 2006

(54) Earphone type player

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/968,941

(22) Filed: Oct. 21, 2004

(51) Int. Cl. H04R 1/10; H04R 25/00

(52) U.S. Cl. 381/74; 381/374; 381/384

(57) ABSTRACT

An earphone type player that comprises a voice player is disclosed, wherein an arc shape shaft having an earphone mounted on a distal end thereof is mounted respectively on both sides of the voice player such that the music stored in the voice player is shown through the earphones located on these two sides when the voice player is actuated. Thus, the user just needs to turn on the voice player so as to show the music stored therein through the earphones. Accordingly, the earphone lines will not limit the body motion of the user while he is doing exercise.

### BACKGROUND OF THE INVENTION

The present invention relates to an earphone type player that facilitates utilization during exercise, and more particularly to a voice player or the like for enjoying listening to digital music.

During the windshield time, it can be seen that many travelers in the public transportation utilize Walkman to achieve the purposes of learning and entertainment. Tape Walkman and CD Walkman are previously utilized. However, the major drawbacks of these two kinds of Walkmans are that they need to change tapes or compact discs, and have large size and heavy weight.

A new generation of Walkman, i.e. voice player, has been made in view of the drawbacks of the aforementioned structure. Since the voice player has smaller size and lighter weight and not needs to change compact discs or tapes, it is widely adopted by young people. It can be seen that almost every day student carries one voice player by using a necklace to hang the voice player on the neck so as to listen to the digital music or voice stored in the voice player through a wired earphone. However, this way is only suitable for commuters, but not suitable for sportsmen. Because of great range of body motion during exercise, interference from the earphone line of the wired earphone can not be avoided even through this voice player has small size, and can be hung on the neck or put in the bag.

Whereas the drawbacks of the aforementioned structures, the present inventor has been made diligent studies with a quiet mind in accordance with motivations of the present invention to provide consumers with an earphone type player that does not interfere with exercise.

### SUMMARY OF THE INVENTION

The main purpose of the present invention is to provide an earphone type player that is not limited by an earphone line so as to easily listen to music during exercise.

According to the aforementioned purposes of the present invention, an earphone type player that comprises a voice player is disclosed, wherein an arc shape shaft having an earphone mounted on a distal end thereof is mounted respectively on both sides of the voice player such that the music stored in the voice player is shown through the earphones located on these two sides when the voice player is actuated. Thus, the user just needs to turn on the voice player so as to show the music stored therein through the earphones. Accordingly, the earphone lines will not limit the body motion of the user while he is doing exercise.

The other features and preferred embodiments of the present invention will now be described with reference to the accompanying drawings.

### BRIEF DESCRIPTION OF THE DRAWINGS

FIG. 1 is a perspective view showing the outward appearance of a first preferred embodiment of the present invention.

FIG. 2 is a decomposed view showing a second preferred embodiment of the present invention.

FIG. 3 is a schematic view showing the usage of the first preferred embodiment of the present invention.

FIG. 4A is a schematic view showing one illustration of the first preferred embodiment of the present invention.

FIG. 4B is a schematic view showing another illustration of the first preferred embodiment of the present invention.

### DETAILED DESCRIPTION OF THE PREFERRED EMBODIMENT

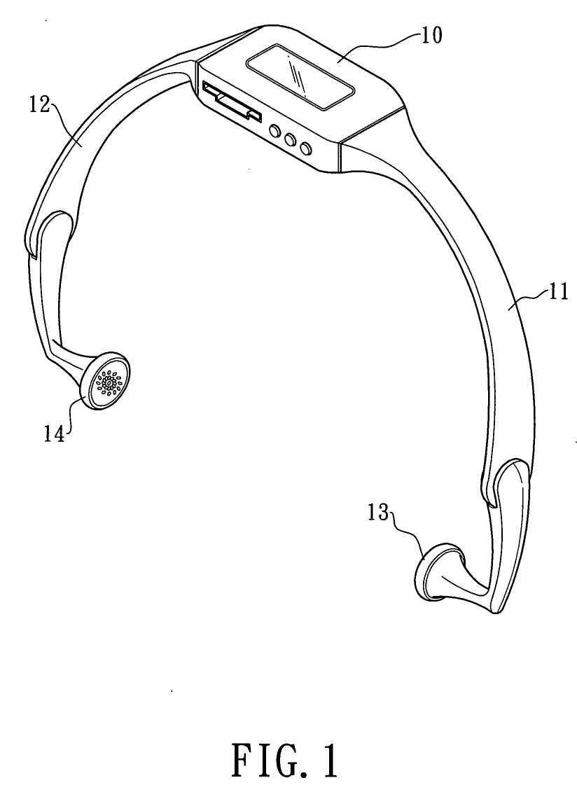

Referring to FIG. 1, an earphone type player of the present invention comprises a voice player 10. A monitor, a plurality of function keys, and a memory card slot are mounted on the voice player 10. In addition, a Bluetooth chip and an auto-switch are mounted on the voice player 10. Arc shape shafts 11 and 12 having earphones 13 and 14 mounted respectively on one distal end thereof are mounted on opposite sides of the voice player 10.

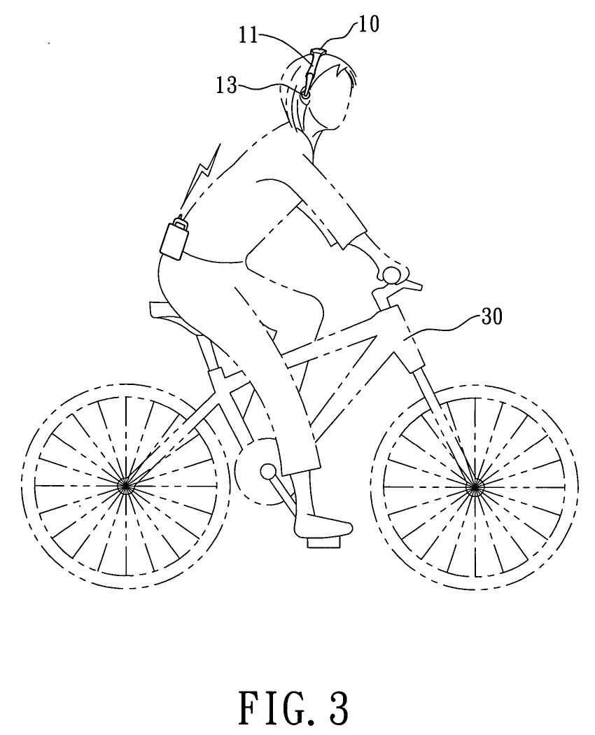

In this way, the voice player 10, the two shafts 11 and 12, and two earphones 13 and 14 are integrated with one another. If a user wants to enjoy listening to digital music stored in the voice player device 10, then he only needs to actuate the voice player device 10 and put the entirety of the present invention on his head so as to put the earphones 13 and 14 into ears such that the user can ride bicycle 30 and listen to music simultaneously, as shown in FIG. 3. Furthermore, during exercise the body motion will not restrained by conventional earphone lines. In addition, since the Bluetooth chip is mounted in the voice player 10, the status of showing music will be automatically switched to the status of answering call if the user who carries a mobile phone gets an incoming call. Therefore, the user does not need to stop the ride in order to take the incoming call.

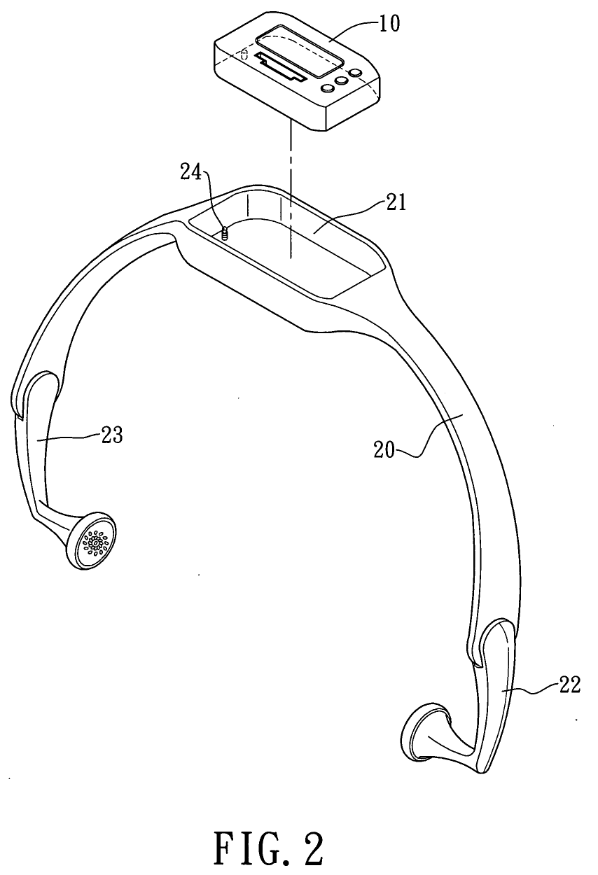

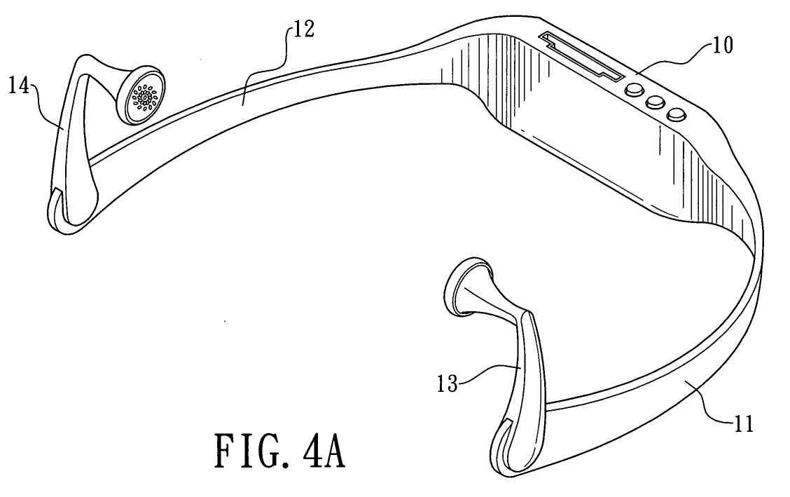

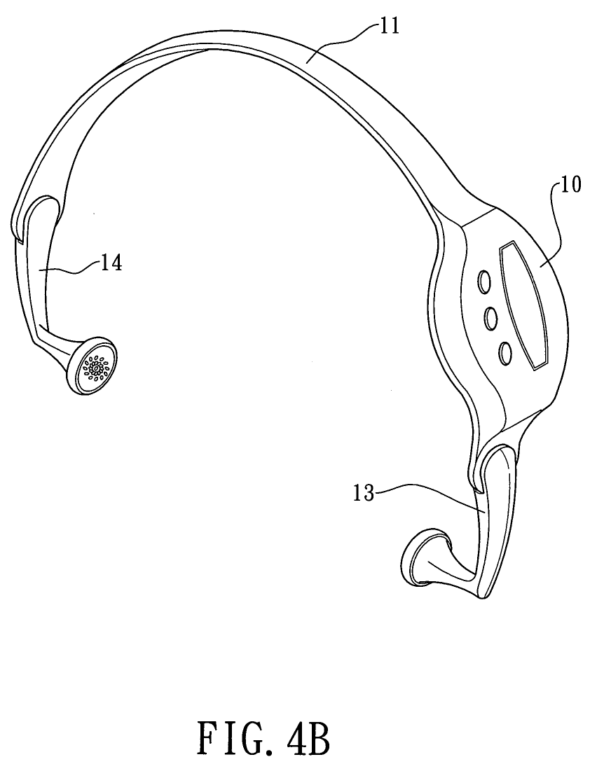

Referring to FIG. 2 again, a second preferred embodiment of the present invention is shown. The second preferred embodiment of the present invention mainly comprises: a voice player 10 and an earphone body. A monitor, a plurality of function keys, an earphone jack, and a memory card slot are mounted on the voice player 10. The earphone body is configured to be an inverted U shape frame 20. Two earphones 22 and 23 are mounted pivotally on two respective ends of the inverted U shape frame 20. An embedded trench 21 is mounted on the inverted U shape frame 20. An earphone plug 24 to be inserted into the earphone jack is mounted inside the embedded trench 21. The voice player 10 is put into the embedded trench 21 so as to enable the earphone plug 24 mounted in the embedded trench 21 to be plugged into the earphone jack of the voice player 10 so as to complete the assembly of the present invention. Since the embedded trench 21 and the earphone plug 24 are combined with one another, the voice player 10 will not come off the embedded trench 21. However, in order to prevent the voice player 10 from falling off the embedded trench 21 of the earphone body during exercise, a hook and loop fastener may be formed on the top of the embedded trench 21. Referring to both FIG. 4A and FIG. 4B, in addition to the central section, the voice player 10 can be mounted on one of two sides of the earphone frame. Besides, the earphone body can be changed from an overhead type to a backside type.

It is apparent that the structure disclosed in the present invention comprises the following practical advantages:

1. Since the voice player integrates with the earphone, earphone line will not confine motion of the user when he is listening to music.

2. Although the earphone line does not confine the present invention, a general wired earphone having the earphone line can be utilized in addition to the earphone of the present invention that has a combination part.

3. Because the Bluetooth chip is built in the voice player of the present invention, if there is an incoming call, it is not necessary to stop exercise and demount the earphone for answering the incoming call when the user is listening to music and doing exercise.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention is able to achieve the expected purpose of providing an earphone type player that is not restrained by earphone line. The application that complies with utility is therefore submitted for a patent.

What the invention claimed is:

1. An earphone type player comprising a voice player, wherein a monitor, a memory card slot, a USB connector, and a plurality of function keys are mounted on the voice player, and an arc shape shaft having an earphone mounted on a distal end thereof is mounted respectively on both sides of the voice player so as to form the earphone type player for listening to music stored in the voice player by actuating the voice player and putting the earphones into ears without using an earphone line.

2. An earphone type player comprising:
a voice player having a monitor, a memory card slot, a USB connector, an earphone jack, and a plurality of function keys mounted thereon; and
an earphone having a connecting rod, wherein an embedded trench for receiving the voice player is mounted on the connecting rod so as to form the earphone type player.

3. The earphone type player of claim 2, wherein a plug to be inserted into the earphone jack of the voice player is mounted in the embedded trench of the earphone.

4. The earphone type player of claim 2, wherein a plug to be inserted into a connecting line is mounted on the earphone for connecting the earphone with the voice player by means of the connecting line.

5. The earphone type player of claim 2, wherein an anti-dropping belt is mounted outside the embedded trench.
